(19) United States
(12) Patent Application Publication
(10) Pub. No.: US 2005/0187127 A1
(43) Pub. Date: Aug. 25, 2005

(54) Laundry detergent composition comprising an anionic detersive surfactant, sulphamic acid and/or water soluble salts thereof, and a sulphate salt

(75) Inventors: Nigel Patrick Somerville Roberts, Newcastle/Tyne (GB); Alan Thomas Brooker, Newcastle/Tyne (GB); James Robert Young, Newcastle/Tyne (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/050,150

(22) Filed: Feb. 3, 2005

(30) Foreign Application Priority Data
Feb. 23, 2004 (EP) 04250968.7

(51) Int. Cl. C11D 1/00

(52) U.S. Cl. 510/336

(57) ABSTRACT

The present invention relates to a laundry detergent composition comprising (i) sulphamic acid and/or water-soluble salts thereof; and (ii) at least 10wt % sulphate salt; and (iii) an anionic detersive surfactant.

### FIELD OF THE INVENTION

The present invention relates to laundry detergent compositions comprising an anionic detersive surfactant, sulphamic acid and/or water-soluble salts thereof, and a sulphate salt.

### BACKGROUND

In a typically laundry wash load, the fabrics that are to be laundered are usually stained and soiled with a wide variety of different stain and soil types. This variation in stain and soil type leads to a demand for laundry detergent compositions to have good cleaning performance on a wide range of different stain and soil types. Laundry detergent manufacturers incorporate numerous cleaning technologies in their laundry detergent products in order to meet this demand for cleaning across a broad spectrum of stain and soil types; the cleaning performance of one cleaning technology being predominantly focused towards a particular stain or soil type. However, these cleaning technologies are not always compatible with one another, with one cleaning technology sometimes negating the cleaning performance of a different cleaning technology. This can result in the cleaning performance of the laundry detergent as a whole, and the cleaning performance of each of the individual cleaning technologies incorporated therein, not performing to its optimum level.

Laundry detergent manufacturers formulate their laundry detergent compositions to ensure that the compatibility between each of the cleaning technologies incorporated therein is as optimized as far as possible. However, laundry detergent manufacturers are still sometimes forced to accept negatives in the cleaning performance against one particular soil type if they wish to improve the cleaning performance against a different soil type in certain usage conditions such as high water hardness; for example greasy soil cleaning performance and whiteness maintenance. Thus, there remains a need for a laundry detergent composition comprising compatible cleaning technologies and in particular there remains a need for a laundry detergent composition that is optimised for both good greasy soil cleaning performance and good whiteness maintenance across a wide range of usage conditions.

### SUMMARY OF THE INVENTION

The present invention overcomes the above problem by providing a laundry detergent composition comprising: (i) sulphamic acid and/or water-soluble salts thereof; and (ii) at least 10wt % sulphate salt; and (iii) anionic detersive surfactant.

### DETAILED DESCRIPTION

The laundry detergent composition is suitable for use in the laundering of fabrics. The detergent composition comprises sulphamic acid and/or water-soluble salts thereof. The water-soluble salts of sulphamic acid can be alkali-metal or an alkaline-earth-metal salts of sulphamate. Other examples of water-soluble salts of sulphamic acid include ammonium sulphamate, zinc sulphamate and lead sulphamate. A preferred water-soluble salt of sulphamic acid is sodium sulphamate. Preferably, the detergent composition comprises sulphamic acid. The detergent composition preferably comprises (on a sulphamic acid basis) from 0.1wt % to 20wt % sulphamic acid, and/or water soluble salts thereof, however it may be preferred that the detergent composition comprises from 0.1wt % to 15wt %, or from 0.1wt % to 8wt %, or even from 0.1wt % to 5wt %, or even from 0.5wt % to 3wt % sulphamic acid and/or water-soluble salts thereof. The sulphamic acid typically has the formula:
H₂NSO₃H
The sulphamic acid can be in zwitterionic form when present in the detergent composition; sulphamic acid in zwitterionic form has the formula:
H₃N⁺SO₃⁻
Possibly at least part of, possibly all of, the sulphamic acid is in zwitterionic form when present in the composition, for example as a separate particulate component.

The sulphamic acid can act to improve the dispensing and disintegration of the detergent composition. It is capable of reacting with a source of carbonate, if present, in an aqueous environment such as the wash liquor in the drum of an automatic washing machine or in the dispensing drawer of an automatic washing machine or some other dispensing device such as a ball (granulette) or a net, to produce carbon dioxide gas. The combination of sulphamic acid and a source of carbonate is an effervescence system that can improve the dispensing performance of the detergent composition. In addition, the extra agitation in the wash liquor provided by this effervescence system can also improve the cleaning performance of the detergent composition.

Sulphamic acid has a very low hygroscopicity, significantly lower than other acids such as citric acid, malic acid or succinic acid; sulphamic acid does not readily pick up water. Sulphamic acid is stable during storage of the detergent composition and does not readily degrade other components of the detergent composition under certain storage conditions such as high humidity. Surprisingly, the sulphamic acid is stable even in the presence of mobile liquid phases, for example non-ionic detersive surfactants. Even more surprisingly, the sulphamic acid does not readily degrade perfumes during storage under high humidity.

Preferably, the sulphamic acid, and/or water-soluble salts thereof, is in particulate form. When the detergent composition is in particulate form, especially a free-flowing particulate form, the sulphamic acid, and/or water-soluble salts thereof, is preferably in particulate form and preferably is incorporated into the detergent composition in the form of dry-added particles, preferably in the form of separate dry-added particles. The sulphamic acid may be in the form of a co-particulate admixture with a source of carbonate, this co-particulate admixture may be produced by methods such as agglomeration including pressure agglomeration, roller compaction, extrudation, spheronisation, or any combination thereof Preferably, the sulphamic acid, and/or water-soluble salts thereof, in particulate form has a weight average particle size in the range of from 210 micrometers to 1,200 micrometers, or preferably from 250 micrometers to 800 micrometers. Preferably, the sulphamic acid, and/or water-soluble salts thereof, in particulate form has a particle size distribution such that no more than 35wt % of the sulphamic acid, and/or water-soluble salts thereof, has a particle size of less than 250 micrometers, preferably no more than 30wt % of the sulphamic acid, and/or water-soluble salts thereof, has a particle size of less than 250 micrometers, and preferably no more than 35wt % of the sulphamic acid, and/or water-soluble salts thereof, has a particle size of greater than 1,000 micrometers, preferably no more than 25wt % of the sulphamic acid, and/or water-soluble salts thereof, has a particle size of greater than 1,000 micrometers.

Sulphamic acid, and/or salts thereof, has a superior building capability than other acids such as citric acid, malic acid, succinic acid and salts thereof. Sulphamate, which is either incorporated in the composition or is formed in-situ in the wash liquor by the in-situ neutralisation of sulphamic acid, has a high binding efficiency with free cations (for example, such as calcium and/or magnesium cations to form calcium sulphamate and/or magnesium sulphamate, respectively). This superior building performance due to the presence of sulphamic acid and/or water-soluble salts thereof in the detergent composition is especially beneficial when the detergent composition comprises very low levels of, or no, zeolite builders and phosphate builders, when cleaning negatives associated with high concentrations of free calcium and/or magnesium cations in the wash liquor are most likely to occur.

One such cleaning negative associated with high concentrations of free calcium and/or magnesium cations in the wash liquor is poor whiteness maintenance. This is especially true when the detergent composition comprises high levels of carbonate.

It may be preferred for the detergent composition to comprise a carbonate salt, typically from 1wt % to 50wt %, or from 5wt % to 25wt % or from 10wt % to 20wt % carbonate salt. A preferred carbonate salt is sodium carbonate and/or sodium bicarbonate. A highly preferred carbonate salt is sodium carbonate. The carbonate salt, or at least part thereof, is typically in particulate form, typically having a weight average particle size in the range of from 200 to 500 micrometers. However, it may be preferred for the carbonate salt, or at least part thereof, to be in micronised particulate form, typically having a weight average particle size in the range of from 4 to 40 micrometers; this is especially preferred when the carbonate salt, or at least part thereof, is in the form of a co-particulate admixture with a non-ionic detersive surfactant.

High levels of carbonate improve the cleaning performance of the detergent composition by increasing the pH of the wash liquor. This increased alkalinity improves the performance of the bleach, if present, increases the tendency of soils to hydrolyse which facilitates their removal from the fabric, and also increases the rate and degree of ionization of the soils to be cleaned; ionized soils are more soluble and easier to remove from the fabrics during the washing stage of the laundering process. In addition, high carbonate levels improve the flowability of the detergent composition when the detergent composition is in free-flowing particulate form.

However, carbonate anions readily complex with free calcium and/or magnesium cations in the wash liquor to form calcium and/or magnesium carbonate, respectively. Calcium carbonate and magnesium carbonate are water-insoluble and can precipitate out of solution in the wash liquor, deposit on soil and fabric surfaces in the wash liquor and result in poor whiteness maintenance. Sulphamate diminishes the formation of calcium and/or magnesium carbonate in the wash liquor by complexing with the free calcium and/or magnesium cations in the wash liquor. In addition, sulphamic acid is capable of reacting with calcium carbonate to form calcium and sulphamate, also liberating carbon dioxide and water; thus removing this calcium carbonate from the wash liquor and mitigating any negative effect on whiteness maintenance. The calcium sulphamate formed in-situ in the wash liquor is water-soluble and does not precipitate out of solution in the wash liquor.

The composition may comprise from 0wt % to 10wt % carbonate salt to minimize the negatives associated with the presence of carbonate salt in the composition. However, as described above in more detail, it may be desirable to incorporate higher levels of carbonate salt in the composition. If the composition comprises high levels of carbonate salt, such as at least 10wt % carbonate salt, then the composition also preferably comprises an acid source that is capable of undergoing an acid/base reaction with a carbonate anion. Acid sources include sulphamic acid, citric acid, malic acid, succinic acid or any mixture thereof. An especially preferred acid source is sulphamic acid. Preferably, the weight ratio of carbonate salt to the total amount of acid source in the composition that is capable of undergoing an acid/base reaction with a carbonate anion, is preferably less than 50:1, more preferably less than 25:1, or less than 15:1, or less than 10:1 or even less than 5:1.

In order to minimise the undesirable effects of having too high a concentration of carbonate anions in the wash liquor, the total amount of carbonate anion source in the composition is preferably limited. Preferred carbonate anion sources are carbonate salts and/or percarbonate salts. Preferably, the total amount of carbonate anion source (on a carbonate anion basis) in the composition is between 7wt % to 14wt % greater than the theoretical amount of carbonate anion source that is required to completely neutralise the total amount of acid source present in the composition that is capable of undergoing an acid/base reaction with a carbonate anion. By controlling the total amount of carbonate anion source in the composition with respect to the amount of acid source in the composition, in the above described manner, all of the benefits of having a carbonate anion source in the composition are maximised whilst all of the undesirable negative effects of having too high a concentration of carbonate anions in the wash liquor are minimised.

The detergent composition comprises at least 10wt % sulphate salt. The sulphate salt is highly preferably water-soluble. A preferred sulphate salt is an alkali-metal salt of sulphate, very highly preferred is sodium sulphate. High levels of sulphate salt can improve the greasy stain removal cleaning performance of the detergent composition. The detergent composition preferably comprises very high levels of sulphate salt; the detergent composition typically comprises at least 15wt % sulphate salt, or even 20wt % sulphate salt, or even 25wt % sulphate salt and sometimes even at least 30wt % sulphate salt.

The sodium sulphate and sulphamic acid are capable of complexing together in the presence of water to form a complex having the formula:
6HSO₃NH₂·5Na₂SO₄·15H₂O
Such complexes are suitable for use herein.

The sulphate salt, or at least part thereof, is typically in particulate form, typically having a weight average particle size in the range of from 60 to 200 micrometers. However, it may be preferred that the sulphate salt, or at least part thereof, is in micronised particulate form, typically having a weight average particle size in the range of from 5 to less than 60 micrometers, preferably from 5 to 40 micrometers. It may even be preferred for the sulphate salt to be in coarse particulate form, typically having a weight average particle size of from above 200 to 800 micrometers.

The detergent composition comprises an anionic detersive surfactant. Preferably, the composition comprises from 5wt % to 25wt % anionic detersive surfactant. Preferably, the composition comprises from 6wt % to 20wt %, or from 7wt % to 18wt %, or from 8wt % to 15wt %, or from 8wt % to 11wt % or even from 9wt % to 10wt % anionic detersive surfactant. The anionic detersive surfactant is preferably selected from the group consisting of: linear or branched, substituted or unsubstituted C₈₋₁₈ alkyl sulphates; linear or branched, substituted or unsubstituted C₈₋₁₈ linear alkylbenzene sulphonates; linear or branched, substituted or unsubstituted C₁₂₋₁₈ alkyl carboxylates; and mixtures thereof. The anionic detersive surfactant can be an alkyl sulphate, an alkyl sulphonate, an alkyl phosphate, an alkyl phosphonate, an alkyl carboxylate or any mixture thereof. The anionic surfactant can be selected from the group consisting of: C₁₀-C₁₈ alkyl benzene sulphonates (LAS), preferably linear C₁₀-C₁₃ alkyl benzene sulphonates; C₁₀-C₂₀ primary, branched-chain, linear-chain and random-chain alkyl sulphates (AS), preferred are linear alkyl sulphates, typically having the following formula:
CH₃(CH₂)ₓCH₂—OSO₃^{-M}⁺,
wherein, M is hydrogen or a cation which provides charge neutrality, preferred cations include sodium and ammonium cations, wherein x is an integer of at least 7, preferably at least 9; C₁₀-C₁₈ secondary (2,3) alkyl sulphates having the following formulae: 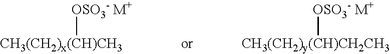
wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₈ alkylbenzene sulphonates, preferably linear C₁₀₋₁₃ alkylbenzene sulphonates; and mixtures thereof. Highly preferred are commercially available C₁₀₋₁₃ linear alkylbenzene sulphonates. Highly preferred are linear C₁₀₋₁₃ alkylbenzene sulphonates that are obtained by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

It may be preferred for the anionic detersive surfactant to be structurally modified in such a manner as to cause the anionic detersive surfactant to be more calcium tolerant and less likely to precipitate out of the wash liquor in the presence of free calcium ions. This structural modification could be the introduction of a methyl or ethyl moiety in the vicinity of the anionic detersive surfactant's head group, as this can lead to a more calcium tolerant anionic detersive surfactant due to steric hindrance of the head group, which may reduce the anionic detersive surfactant's affinity for complexing with free calcium cations in such a manner as to cause precipitation out of solution. Other structural modifications include the introduction of functional moieties, such as an amine moiety, in the alkyl chain of the anionic detersive surfactant; this can lead to a more calcium tolerant anionic detersive surfactant because the presence of a functional group in the alkyl chain of an anionic detersive surfactant may minimise the undesirable physicochemical property of the anionic detersive surfactant to form a smooth crystal structure in the presence of free calcium ions in the wash liquor. This may reduce the tendency of the anionic detersive surfactant to precipitate out of solution.

The presence of potassium cations in the detergent composition is not preferred due to the negative effect the potassium cations have on the cleaning performance of the detergent composition. Therefore, the detergent composition preferably comprises less than 10wt %, preferably less than 5wt %, or even less than 2wt %, or even less than 1wt %, or even less than 0.2wt %, or even less than 0.1wt %, or even less than 0.05wt %, or even less than 0.04wt % potassium cations. Most preferably, the detergent composition is substantially free from, or even completely free from, deliberately added potassium cations.

The detergent composition typically comprises at least one other adjunct component.

The detergent composition may comprise other adjunct detersive surfactants in addition to the anionic detersive surfactant. The composition may comprise a non-ionic detersive surfactant, a cationic detersive surfactant, a zwitterionic detersive surfactant, an amphoteric detersive surfactant or a mixture thereof. The composition may comprise an adjunct detersive surfactant selected from the group consisting of: linear or branched, substituted or unsubstituted C₁₂₋₁₈ alkyl carboxylic acids; linear or branched, substituted or unsubstituted C₈₋₁₈ alkyl ethoxylated alcohols having an average degree of ethoxylation of from 1 to 10; linear or branched, substituted or unsubstituted C₁₂₋₂₄ alkyl N-methyl glucose amides; linear or branched, substituted or unsubstituted C₈₋₁₈ alkyl polyglucosides; amine oxides; linear or branched, substituted or unsubstituted C₁₂₋₂₄ alkyl betaines; linear or branched, mono-alkyl mono-hydroxyethyl di-methyl quaternary ammonium compounds; and mixtures thereof. Preferred quaternary ammonium cationic detersive surfactants have the formula:
(R)(R¹)(R²)(R³)N⁺X⁻
wherein, R is a linear or branched, substituted or unsubstituted C₆₋₁₈ alkyl or alkenyl moiety, R¹ and R² are independently selected from methyl or ethyl moieties, R³ is a hydroxyl, hydroxymethyl or a hydroxyethyl moiety, X is an anion which provides charge neutrality, preferred anions include halides (such as chloride), sulphate or sulphonate. Preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono C₁₀ alkyl mono-hydroxyethyl di-methyl quaternary ammonium chloride.

Typically, the detergent composition comprises more than one type of detersive surfactant in order to obtain a good cleaning performance across a broad spectrum of soil types and in a broad range of washing conditions. It may be preferred for the detergent composition to comprise a substantially hardness tolerant detersive surfactant system; this is especially preferred when the detergent composition comprises very low levels of, or no, zeolite builder and phosphate builder, or if the detergent composition is for use in hard water conditions. A preferred substantially hardness tolerant surfactant system is one that comprises anionic detersive surfactant, non-ionic detersive surfactant and optionally a cationic detersive surfactant. Preferably, the detergent composition comprises from 7wt % to 15wt %, preferably from 8wt % to 12wt % anionic detersive surfactant, from 2wt % to 6wt %, preferably from 2wt % to 4wt % non-ionic detersive surfactant and optionally from 0.5wt % to 2wt %, preferably from 1wt % to 2wt % cationic detersive surfactant. This surfactant system is especially preferred when the detergent composition comprises low levels of, or no, zeolite builder and phosphate builder.

The detergent composition may comprise from 1wt % to 40wt % adjunct builder other than sulphamic acid and/or water-soluble salts thereof, especially preferred are water-soluble adjunct builders. Adjunct builders are preferably selected from the group consisting of sodium carbonate, citric acid and/or water soluble salts thereof such as sodium citrate; polymeric polycarboxylates such as co-polymers of acrylic acid and maleic acid, or polyacrylate; zeolite; and any mixture thereof.

However, it may be preferred for the detergent composition to comprise low levels of adjunct builders, especially water-insoluble adjunct builders such as zeolite. This is especially preferred if it is desirable for the detergent composition to be very highly soluble. In addition, the detergent composition may comprise low levels of adjunct builders such as phosphate builders (e.g. sodium tripolyphosphate): for example, due to the phosphate regulations of a number of countries. It may be preferred for the detergent composition to comprise less than 9wt % zeolite builders and less than 9wt % phosphate builders, or even less than 5wt % zeolite builders and less than 5wt % phosphate builders, or even less than 2wt % zeolite builders and less than 2wt % phosphate builders, or even less than 1wt % zeolite builders and less than 1wt % phosphate builders. It may be preferred that the composition is substantially free from, or even completely free from, deliberately added zeolite builders and phosphate builders. Phosphate builders include sodium tripolyphosphate. Zeolite builders include zeolite A, zeolite P, zeolite MAP and zeolite X.

The detergent composition typically comprises adjunct components. These detergent adjunct components include: bleach such as percarbonate and/or perborate; bleach such as percarbonate and/or perborate, preferably in combination with a bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-Pthaloylamino peroxycaproic acid, nonylamido peroxyadipic acid or dibenzoyl peroxide; chelants such as diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid); enzymes such as amylases, carbohydrases, celluloses, laccases, lipases, oxidases, peroxidases, and proteases; suds suppressing systems such as silicone based suds suppressors; brighteners; photobleach; filler salts; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; dispersants such as polycarboxylates, alkoxylated polyamines and ethoxylated ethyleneimine polymers; and anti-redeposition components such as carboxymethyl cellulose and polyesters. Preferably, the detergent composition comprises less than 1wt % chlorine bleach and less than 1wt % bromine bleach. Preferably, the detergent composition is free from deliberately added bromine bleach and chlorine bleach.

The detergent composition can be in any form, for example the detergent composition can be in the form of a liquid. Alternatively, and preferably, the detergent composition is in the form of a solid; such as in form of free-flowing particles or in the form of a tablet. Preferably, the detergent composition is in the form of free-flowing particles such as agglomerates, extrudates, spray-dried particles, noodles, needles, flakes and mixtures thereof. It may be preferred that the composition is not in tablet form. It may be preferred for the composition to be a granular laundry detergent composition. The detergent composition in free-flowing particulate form typically has a bulk density of from 450 g/l to 1,000 g/l, preferred low bulk density detergent compositions have a bulk density of from 550 g/1 to 650 g/1 and preferred high bulk density detergent compositions have a bulk density of from 750 g/l to 900 g/l. During the laundering process, the composition is typically contacted with water to give a wash liquor having a pH of from above 7 to 11, preferably from 8 to 10.5.

### EXAMPLES

### Example 1

Aqueous slurry.

| | Amount |
|---|---|
| Component | (slurry parts) |
| Sodium linear alkyl benzene sulphonate | 6.24 |
| Ethylenediamine disuccinic acid | 0.15 |
| Brightener | 0.05 |
| Magnesium sulphate | 0.70 |
| Acrylate/maleate copolymer | 1.50 |
| Hydroxyethane di(methylene phosphonic acid) | 0.10 |
| Sodium carbonate | 10.00 |
| Sodium sulphate | 18.00 |
| Tallow alcohol sulphate | 1.75 |
| Zeolite A | 9.74 |
| Sulphamic acid (mixed grade) supplied by Rhodia | 2.93 |
| Miscellaneous | 0.97 |
| Water | 21.33 |
| Total slurry parts | 73.47 |

Preparation of a Spray-dried Powder

The above described aqueous slurry is heated to 80° C., while the ingredients are being added they are continuously being agitated. Once all the ingredients have been added they are mixed for a further 60 seconds. During this step, the sulphamic acid is neutralised to the sodium salt form by sodium carbonate. The slurry is then fed under high pressure, (from 5.5×10⁶ Nm⁻² to 6.0×10⁶ Nm⁻²), into a counter-current spray drying tower with an air inlet temperature of 300-310° C. The slurry is atomised and the atomised slurry is dried to produce a solid mixture which is then cooled and sieved to remove oversize material (>2 mm) to produce a spray-dried powder. Fine material (<0.15 mm) is elutriated with the exhaust air in the spray-drying tower and collected in a containment system. The spray dried powder has a moisture content of 5wt %, and a bulk density of 450 g/l. The composition of the spray-dried powder is given below.

Spray-dried powder.

| | Amount |
|---|---|
| | (spray-dried |
| Component | powder parts) |
| Sodium linear alkyl benzene sulphonate | 6.24 |
| Ethylenediamine disuccinic acid | 0.15 |
| Brightener | 0.05 |
| Magnesium sulphate | 0.70 |
| Acrylate/maleate copolymer | 1.50 |
| Hydroxyethane di(methylene phosphonic acid) | 0.10 |
| Sodium carbonate | 8.40 |
| Sodium sulphate | 13.00 |
| Sodium chloride | 5.00 |
| Tallow alcohol sulphate | 1.75 |
| Zeolite A | 9.74 |
| Sodium sulphamate | 3.60 |
| Miscellaneous | 0.99 |
| Water | 3.02 |
| Total spray dried powder parts | 54.24 |

Preparation of a Granular Laundry Detergent Composition in Accordance with the Present Invention

13.56 kg of the spray dried powder is dry mixed in a mixer with a total of 10.89 kg other dry added material to produce a dry-mixed material. The dry mixing stage is carried out for 30 minutes in a small scale (1 m diameter) concrete mixer operating at 24 rpm, in order to simulate factory mixing conditions and ensure that the granules are homogeneously distributed. 0.5 kg Non-ionic surfactant (ethoxylated alkyl alcohol having an average degree of ethoxylation of 7 (AE7)) at 60° C. temperature is then sprayed onto the dry-mixed material using the same concrete mixer rotating at 24 rpm. After the non-ionic surfactant is sprayed on to the dry-mixed material, 0.05kg of perfume is then sprayed on to the dry-mixed material to produce a granular laundry detergent composition in accordance with the present invention. The formulation of the granular laundry detergent composition in accordance with the present invention is given below.

A granular laundry detergent composition in
accordance with the present invention.

| | % w/w |
|---|---|
| Component | Composition |
| Dry-added material: | |
| Spray-dried powder of example 1 | 54.24 |
| TAED agglomerate (92% active) | 3.60 |
| Suds suppressor agglomerate (11.5% active) | 0.40 |
| Soap | 0.40 |
| Coloured speckles | 0.30 |
| Sodium percarbonate (having from 12% to | 10.00 |
| 15% active AvOx) | |
| Sodium sulphate | 8.52 |
| Sodium carbonate | 16.44 |
| Sulphamic acid (mixed grade) supplied by Rhodia | 3.50 |
| Enzymes | 0.40 |
| Liquid-added material: | |
| Non-ionic detersive surfactant (AE7) | 2.00 |
| Perfume spray-on | 0.20 |
| Total Parts | 100.00 |

The finished product had a bulk density of 610 g/l and was free flowing.

### Examples 2-5

Four granular detergent products comprising sulphamic acid are prepared by mixing the following materials together. The sulphamic acid used is granular “Mixed Grade” supplied by Rhodia. Production of the spray dried powder is by the same method as described in example 1. The dry mixing step is carried out for 30 minutes in a small scale (1 m diameter) concrete mixer operating at 24 rpm, in order to simulate factory mixing conditions and ensure that the granules are distributed homogeneously.

Following the dry mixing step, AE7 non-ionic detersive surfactant at 60° C. temperature is sprayed onto the dry mixed material in the same concrete mixer operating at 24 rpm.

The formulation of the resultant granular laundry detergent compositions in accordance with the present invention are given below.

| | Example compositions | | | |
|---|---|---|---|---|
| | 2-5 (wt %) | | | |
| Component | 2 | 3 | 4 | 5 |
| Spray-dried powder components: | | | | |
| Linear alkyl benzene sulphonate | 6.21 | 6.21 | 5.65 | 0.00 |
| Cationic detersive surfactant | 0.00 | 0.00 | 0.00 | 2.95 |
| Ethylene diamine disuccinic acid | 0.19 | 0.19 | 0.19 | 0.23 |
| Brightener | 0.07 | 0.07 | 0.06 | 0.08 |
| Magnesium sulphate | 0.65 | 0.65 | 0.39 | 0.48 |
| Acrylate/maleate copolymer | 1.42 | 1.42 | 3.50 | 4.25 |
| Hydroxyethane di(methylene phosphonic acid) | 0.17 | 0.17 | 0.17 | 0.21 |
| Sodium carbonate | 9.44 | 9.44 | 2.77 | 0.00 |
| Sodium sulphate | 22.67 | 22.67 | 26.43 | 32.13 |
| Tallow alcohol sulphate | 1.42 | 1.42 | 0.81 | 0.00 |
| Zeolite A | 13.65 | 13.65 | 0.00 | 0.00 |
| Miscellaneous | 1.11 | 1.11 | 0.22 | 0.27 |
| Water | 3.00 | 3.00 | 0.41 | 0.41 |
| Total spray dried powder parts | 60.00 | 60.00 | 40.61 | 41.00 |
| Dry-added material: | | | | |
| Cationic detersive surfactant particle of | 0.00 | 0.00 | 6.00 | 0.00 |
| examples 2-5 | | | | |
| Non-ionic detersive surfactant particle of | 0.00 | 0.00 | 11.44 | 9.05 |
| examples 2-5 | | | | |
| 91.6 wt % active linear alkyl benzene sulphonate | 0.00 | 0.00 | 3.20 | 0.00 |
| flake supplied by Stepan under the tradename | | | | |
| Nacconol 90G ® | | | | |
| Acrylate/maleate copolymer particle (95.7% | 0.00 | 0.00 | 0.89 | 0.89 |
| active) | | | | |
| Tetraacetyl ethylene diamine agglomerate | 3.58 | 3.58 | 3.80 | 2.70 |
| (92 wt % active) | | | | |
| Anionic detersive surfactant particle | 0.00 | 0.00 | 0.00 | 30.00 |
| Suds suppressor agglomerate (11.5% active) | 0.36 | 0.36 | 0.36 | 0.55 |
| Soap | 0.40 | 0.40 | 0.40 | 0.40 |
| Granular 2 ratio silicate | 3.85 | 3.85 | 3.85 | 2.80 |
| Coloured speckles | 0.27 | 0.27 | 0.27 | 0.27 |
| Sodium percarbonate (having from 12% to 15% | 11.01 | 11.01 | 11.01 | 8.00 |
| active AvOx) | | | | |
| Sodium sulphate | 4.48 | 4.48 | 0.00 | 0.00 |
| Sodium carbonate | 7.72 | 7.72 | 13.84 | 0.00 |
| Sulphamic acid | 3.58 | 1.79 | 3.58 | 3.58 |
| Citric acid | 0.00 | 1.79 | 0.00 | 0.00 |
| Enzymes | 0.55 | 0.55 | 0.55 | 0.55 |
| Liquid-added material: | | | | |
| Non-ionic detersive surfactant (AE7) | 4.00 | 4.00 | 0.00 | 0.00 |
| Perfume spray-on | 0.20 | 0.20 | 0.20 | 0.20 |
| Total parts | 100 | 100 | 100 | 100 |

The products produced each had a bulk density of at least 600 g/l and all were free flowing. The particles used in these products are described in more detail below.
Cationic Detersive Surfactant Particle

The cationic surfactant particle used in examples 2-5 is made on a 14.6 kg batch basis on a Morton FM-50 Loedige. 4.5 kg of micronised sodium sulphate and 4.5 kg micronised sodium carbonate is premixed in the mixer. 4.6 kg of 40% active mono-C₁₂₋₁₄ alkyl mono-hydroxyethyl di-methyl quaternary ammonium chloride (cationic surfactant) aqueous solution is added to the micronised sodium sulphate and micronised sodium carbonate in the mixer whilst both the main drive and the chopper are operating. After approximately two minutes of mixing, a 1.0 kg 1:1 weight ratio mix of micronised sodium sulphate and micronised sodium carbonate is added to the mixer as a dusting agent. The resulting agglomerate is collected and dried using a fluid bed dryer on a basis of 2500 l/min air at 100-140° C. for 30 minutes. The resulting powder is sieved and the fraction through 1400 μm is collected as the cationic surfactant particle. The composition of the cationic surfactant particle is as follows:

| Component | % w/w Particle |
|---|---|
| mono-C₁₂₋₁₄ alkyl mono-hydroxyethyl di-methyl | 15.00 |
| quaternary ammonium chloride | |
| Sodium carbonate | 40.76 |
| Sodium sulphate | 40.76 |
| Moisture and miscellaneous | 3.48 |

Non-ionic Detersive Surfactant Particle

The non-ionic detersive surfactant particle used in examples 2-5 is made on a 25 kg batch basis using a 1 m diameter cement mixer at 24 rpm. 18.9 kg light grade sodium sulphate supplied by Hamm Chemie under the tradename Rombach Leichtsulfat® is added to the mixer and then 6.1 kg C₁₄₋₁₅ ethoxylated alkyl alcohol having an average degree of ethoxylation of 7 (AE7) in liquid form is sprayed onto the sodium sulphate at 40° C.; and the mixture is mixed for 3 minutes to produce the non-ionic detersive surfactant particle, which is free flowing. The composition of the non-ionic detersive surfactant particle is as follows:

| Component | % w/w particle |
|---|---|
| NC₁₄₋₁₅ ethoxylated alkyl alcohol having an average | 24.40 |
| degree of ethoxylation of 7 (AE7) | |
| Sodium sulphate | 75.60 |

Anionic Detersive Surfactant Particle

The linear alkyl benzene sulphonate particle used in examples 2-5 is made on a 14 kg batch basis on a Morton FM-50 Loedige. 7.84 kg micronised sodium sulphate and 2.70 kg micronised sodium carbonate are first added to the mixer while the main drive and chopper are operating. Then 3.46 kg linear alkyl benzene sulphonate paste (78wt % active) is added to the mixer and mixed for 2 minutes to produce a mixture. The resulting mixture is collected and dried using a fluid bed dryer on a basis of 2500 l/min air at 100-140° C. for 30 minutes to produce the anionic detersive surfactant particle. The composition of the anionic detersive surfactant particle is as follows:

| | % w/w |
|---|---|
| Component | Particle |
| Linear alkyl benzene sulphonate | 20.00 |
| Sodium sulphate | 58.00 |
| Sodium Carbonate | 20.00 |
| Moisture and miscellaneous | 2.00 |

### Examples 6-9

Four granular detergent products containing sulphamic acid are prepared by mixing the following materials together. The sulphamic acid used was granular “mixed grade” supplied by Rhodia. A dry-mixing step is carried out for 30 minutes in a small scale (1 m diameter) concrete mixer operating at 24 rpm, in order to simulate factory mixing conditions and ensure that the granules were distributed homogeneously. Following the dry mixing step, non-ionic detersive surfactant (AE7) at 60° C. temperature is sprayed onto the mixed powders in the same concrete mixer operating at 24 rpm. Immediately after the non-ionic surfactant is added, Zeolite is dosed in to the mixer and the mixing was continued for a further 5 minutes.

| | Example Compositions 6-9 | | | |
|---|---|---|---|---|
| | (wt %) | | | |
| Component | 6 | 7 | 8 | 9 |
| Dry-added material: | | | | |
| Surfactant agglomerate 1 | 38.95 | 42.75 | 0.00 | 38.95 |
| Surfactant agglomerate 2 | 0.00 | 0.00 | 40.59 | 0.00 |
| TAED agglomerate (92% Active) | 5.89 | 5.89 | 6.14 | 5.89 |
| Suds suppressor agglomerate (11.5% active) | 0.62 | 0.62 | 0.64 | 0.62 |
| Soap | 0.48 | 0.48 | 0.50 | 0.48 |
| Granular 2 ratio silicate | 6.84 | 7.79 | 7.13 | 6.84 |
| Coloured speckles | 0.95 | 0.00 | 0.99 | 0.95 |
| Sodium percarbonate (having from 12% to 15% | 8.55 | 8.55 | 8.91 | 8.55 |
| active AvOx) | | | | |
| Sodium sulphate | 14.30 | 22.85 | 14.90 | 14.30 |
| Sodium carbonate | 12.35 | 0.00 | 12.87 | 12.35 |
| Sulphamic acid | 3.80 | 3.80 | 3.96 | 1.90 |
| Granular citric acid | 0.00 | 0.00 | 0.00 | 1.90 |
| Brightener | 0.10 | 0.10 | 0.10 | 0.10 |
| Hydroxyethane di(methylene phosphonic acid) | 0.48 | 0.48 | 0.50 | 0.48 |
| Acrylate/maleate copolymer particle (95.7% active) | 0.95 | 0.95 | 0.99 | 0.95 |
| Enzymes | 0.76 | 0.76 | 0.79 | 0.76 |
| Material added post dry-mixing: | | | | |
| Non-ionic detersive surfactant (AE7) | 3.00 | 3.00 | 1.00 | 3.00 |
| spray-on | | | | |
| Zeolite dusting | 2.00 | 2.00 | 0.00 | 2.00 |
| Total Parts | 100 | 100 | 100 | 100 |

The products produced each had a bulk density of at least 800 g/l and all were free flowing. The surfactant agglomerates used in these products are described in more detail below.
Surfactant Agglomerate 1

The surfactant agglomerate 1 used in examples 6-9 is made on a 13.1 kg batch basis on a Morton FM-50 Loedige. Linear Alkyl benzene sulphonate paste (78% active) is added together with zeolite A to the mixer whilst both the main drive and the chopper are operating. After approximately two minutes of mixing, 1.0 kg of zeolite is added to the mixer as a dusting agent. The resulting powder is collected and dried using a fluid bed dryer on a basis of 2500 l/min air at 100-140° C. for 30 minutes. The resulting powder is sieved and the fraction through 1400um was collected as the surfactant agglomerate 1. The composition of the surfactant agglomerate 1 is given below.

| Component | % w/w Agglomerate |
|---|---|
| Sodium alkyl benzene sulphonate | 35.00 |
| Zeolite A | 55.00 |
| Miscellaneous and water | 10.00 |

Surfactant Agglomerate 2

The linear alkyl benzene sulphonate particle used in examples 6-9 is made on a 14 kg batch basis on a Morton FM-50 Loedige. 7.84 kg micronised sodium sulphate and 2.70 kg micronised sodium carbonate are first added to the mixer while the main drive and chopper are operating. Then 3.46 kg linear alkyl benzene sulphonate paste (78wt % active) is added to the mixer and mixed for 2 minutes to produce a mixture. The resulting mixture is collected and dried using a fluid bed dryer on a basis of 2500 l/min air at 100-140° C. for 30 minutes to produce the anionic detersive surfactant particle. The composition of the anionic detersive surfactant particle is as follows:

| Component | % w/w Agglomerate |
|---|---|
| linear alkyl benzene sulphonate | 20.00 |
| Sodium sulphate | 58.00 |
| Sodium carbonate | 20.00 |
| Miscellaneous and water | 2.00 |

### Example 10

Sulphamic Acid Agglomerate

Fine grade granular sulphamic acid is formed into agglomerated particles by the following process: 10.00 kg of granular sulphamic acid together with 2.25 kg of zeolite is added to a Morton FM-50 Loedige. With the main drive and the chopper unit on the mixer were operating, 2.25 kg of molten PEG-4000 at 65° C. is added to the mixer. Once the PEG-4000 is completely added, 500 g of zeolite is added to act as a dusting agent. The mixing operation is allowed to continue until the PEG-4000 is completely solidified. The resulting powder is sieved and the fraction through 1400 um and collected as the sulphamic acid agglomerate. The composition is as follows:

| | |
|---|---|
| Component | % w/w Sulphamic acid particle |

| | |
|---|---|
| Sulphamic Acid | 70.00 |
| PEG-4000 | 15.00 |
| Aluminosilicate | 15.00 |
| Total parts | 100.00 |

The sulphamic acid agglomerate produced is free flowing and is used to produce a granular laundry detergent composition in accordance with the present invention. The formulation of the granular laundry detergent composition produced that is in accordance with the present invention is given below.

| | % w/w |
|---|---|
| | Composition |
| Component | of example 10 |
| Dry-added material: | |
| Surfactant agglomerate 1 (as described in examples 6-9) | 38.95 |
| TAED agglomerate (92% Active) | 5.89 |
| Suds suppressor agglomerate (11.5% active) | 0.62 |
| Soap | 0.48 |
| Granular 2 ratio silicate | 6.84 |
| Coloured speckles | 0.95 |
| Sodium percarbonate (having from 12% to 15% active | 8.55 |
| AvOx) | |
| Sodium sulphate | 14.30 |
| Sodium carbonate | 10.71 |
| Sulphamic acid agglomerate | 5.42 |
| Brightener | 0.10 |
| Hydroxyethane di(methylene phosphonic acid) | 0.48 |
| Acrylate/maleate copolymer particle (95.7% active) | 0.95 |
| Enzymes | 0.76 |
| Material added post dry-mixing: | |
| Non-ionic surfactant (AE7) spray-on | 3.00 |
| Zeolite dusting | 2.00 |
| Total Parts | 100 |

The resulting product had a density of 850 g/l

All documents cited in the Detailed Description of the Invention are, in relevant part, incorporated herein by reference; the citation of any document is not to be construed as an admission that it is prior art with respect to the present invention.
While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A laundry detergent composition comprising:
(i) sulphamic acid and/or water soluble salts thereof; and
(ii) at least about 10 wt % sulphate salt; and
(iii) an anionic detersive surfactant.

2. A composition according to claim 1, wherein the composition is in the form of free-flowing particles.

3. A composition according to claim 1, wherein the composition comprises at least about 15wt % sulphate salt.

4. A composition according to claim 1, wherein the composition comprises less than about 0.04wt % potassium cations.

5. A composition according to claim 1, wherein the composition comprises from about 0.1wt % to about 5wt % sulphamic acid and/or water soluble salts thereof.

6. A composition according to claim 1, wherein the sulphamic acid, and/or water-soluble salts thereof, is in particulate form and has a weight average particle size in the range of from about 250 micrometers to about 800 micrometers, optionally the sulphamic acid and/or water soluble salts thereof has a particle size distribution such that no more than about 35wt % sulphamic acid, and/or water-soluble salts thereof, has a particle size of less than about 250 micrometers and no more than about 35wt % sulphamic acid, and/or water-soluble salts thereof, has a particle size of greater than about 1,000 micrometers.

7. A composition according to claim 1, wherein the composition comprises less than about 9wt % zeolite builders and less than about 9wt % phosphate builders.

8. A composition according to claim 1, wherein the composition comprises from about 7wt % to about 15wt % anionic detersive surfactant, from about 2wt % to about 5wt % non-ionic detersive surfactant and optionally from about 0.5wt % to about 2wt % cationic detersive surfactant.

9. A composition according to claim 1, wherein the composition comprises from about 10wt % to about 20wt % carbonate salt.

10. A composition according to claim 1, wherein the composition comprises citric acid.

11. A composition according to claim 1, wherein the composition comprises carbonate salt and wherein if the composition comprises more than about 10wt % carbonate salt, then the weight ratio of carbonate salt to sulphamic acid is less than about 5:1.

12. A composition according to claim 1, wherein the composition comprises:
(i) a carbonate anion source; and
(ii) an acid source, which includes sulphamic acid, that is capable of undergoing an acid/base reaction with a carbonate anion,
wherein the total amount of carbonate anion source, on a carbonate anion basis, in the composition is between about 7wt % to about 14wt % greater than the theoretical amount of carbonate anion source that is required to completely neutralise the total amount of acid source present in the composition that is capable of undergoing an acid/base reaction with a carbonate anion.

13. A composition according to claim 1, wherein the anionic detersive surfactant is a linear alkyl benzene sulphonate.
